(19) United States
(12) Patent Application Publication
(10) Pub. No.: US 2009/0063993 A1
(43) Pub. Date: Mar. 5, 2009

(54) SYSTEM AND METHOD FOR WORKFLOW TO ALLOW MEETING INVITEES TO SUBSCRIBE AS DEPENDENTS OF OTHER INVITEES

(75) Inventor: Nagendra V. Nyamgondalu, Framingham, MA (US)

Correspondence Address: CANTOR COLBURN LLP - IBM BOCA RATON, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/848,870

(22) Filed: Aug. 31, 2007

(51) Int. Cl. G06F 3/00

(52) U.S. Cl. 715/752

(57) ABSTRACT

The present invention provides a system and method for managing a meeting notice. The system includes a dependency set module that enables a participant to define at least one dependent participant and optionally specify an automatic response to the meeting invitation based on the targeted participant's response, and a determination module that determines if the person scheduling a meeting will allow a participant to subscribe as a dependent of” at least one other participant of the meeting. The determination module, to prevent mutual dependence between two participants, will not allow the participant to subscribe as a dependent if the targeted participant is indicated as a dependent of the requesting participant. The system includes a delivery module that delivers a dependency notice to the participant and, to the at least one targeted participant if the person scheduling a meeting has chosen to allow dependencies by default, and delivers a FYI notice to the person scheduling the meeting if dependencies are allowed by default and delivers a response to the meeting invite if the dependent participant has specified an automatic response based on the targeted participant's response.

### BACKGROUND OF THE INVENTION

1. Field of the Invention

This invention generally relates to methods and apparatus for electronic calendars and particularly to allow meeting invitees to subscribe as dependent of other meeting invitees.

2. Description of Background

In any business setting where an electronic calendar system is used to schedule meetings, there are situations where an invitee's response is dependent on the response of one or more other invitees. ]-or instance when a manager would like to attend a meeting only if one or more of her team members are attending the meeting. The converse can be when two peers are invited to a meeting and would prefer to attend the meeting only if the other is unavailable, to avoid redundancy. Providing dependent invitees a mechanism to formally request and obtain such information, within the workflow framework of the calendar system, will help such invitees avoid unproductive or redundant meetings.

There really is no reliable solution currently available for the problem that this invention is intended to address. In a current day electronic calendar where this workflow is not available, the dependent invitee will have to use an informal method outside of the workflow by either querying the chair or the invitee(s) on whom the dependent depends (to help differentiate, we will refer to this invitee as the “target invitee”). Use of such methods outside the workflow, has significant drawbacks;

If the dependent invitee chooses to query the target invitee(s)—the target invitee(s) will have the additional task of responding to queries, though their response has already been recorded in the calendar system. And in this case, the chair will be left out of the loop and will not be aware that at least one of the invitees is depending on another.

If the chair is aware of the dependence, he/she will be able to plan the meeting agenda better. If the dependent invitee chooses to query the chair, the chair will have the additional task of keeping the dependent invitee apprised of every change to the target invitee's response. Calendar management will become unstruct red for the dependent invitee since he/she will have to rely on responses outside of the workflow.

### SUMMARY OF THE INVENTION

Embodiments of the present invention provide a system and method for managing a meeting notice. The system includes a dependency set module that enables a participant to define at least one dependent participant and optionally specify an automatic response to the meeting invitation based on the targeted participant's response, and a determination module that determines if the person scheduling a meeting will allow a participant to subscribe as a dependent of at least one other participant of the meeting. Wherein the dependency determination module, to prevent mutual dependence between two participants, will not allow the participant to subscribe as a dependent if the targeted participant is indicated as a dependent of the requesting participant. The system also includes a delivery module that delivers a dependency notice to the participant and, to the at least one targeted participant if the person scheduling a meeting has chosen to allow dependencies by default. The delivery module also delivers a FYI notice to the person scheduling the meeting if dependencies are allowed by default and delivers a response to the meeting invite if the dependent participant has specified an automatic response based on the targeted participant's response.

Embodiment of the present invention can also be viewed as providing methods for managing a meeting notice. In this regard, one embodiment of such a method, among others, can be broadly summarized by the following steps. The method operates by (1) enabling a participant to define a dependence on at least one other participant and optionally specify an automatic response to the meeting based on the at least one other participant's response; (2) determining if the targeted participant is indicated as a dependent on the requesting participant and if found to be true, disallowing the dependence; (3) determining if the person scheduling the meeting allows dependencies by default; (4) delivering a request to the person scheduling the meeting for approval, if the person scheduling the meeting does not allow dependencies by default; (5) determining if the person scheduling the meeting allows the requested dependency explicitly by approving the request; (6) delivering the dependency notice to the dependent participant and, to the at least one targeted participant if the person scheduling the meeting has chosen to allow the dependency; (7) determining if the dependent participant has specified an automatic response to the invitation based on the at least one targeted participant's response; and (8) delivering a response based on the at least one targeted participant's response, if the dependent participant has specified an automatic response.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of a computer utilizing the meeting invitees to subscribe as dependents of other invitees system of the present invention.

FIG. 2 is a flow chart illustrating an example of the operation of the meeting invitees to subscribe as dependents of other invitees system of the present invention, as shown inn FIG. 1.

FIG. 3 is a flow chart illustrating an example of the operation of the response to meeting invite module on the computer that is utilized in the meeting invitees to subscribe as dependents of other invitees system of the present invention, as shown in FIGS. 1 and 2.

FIG. 4 is a flow chart illustrating an example of the operation of the query module on the computer that is utilized in the meeting invitees to subscribe as dependents of other invitees system of the present invention, as shown in FIGS. 1 and 2.

The detailed description explains the preferred embodiments of the invention, together with advantages and features, by way of example with reference to the drawings.

### DETAILED DESCRIPTION OF THE INVENTION

This invention disclosure presents a novel system and process for allowing meeting invitees to subscribe as dependents of other invitees.

When a chair is scheduling a meeting using an electronic calendar system, they have an option to allow dependencies by default. If they do not choose this option, all requests for dependencies from invitees for that meeting, will be sent to them for approval. When an invitee receives the meeting invite, they have the option of subscribing as a dependent of one or more other invitees. When requesting this, the user can also specify an automatic response to the meeting based on the response of one or more of the invitees. However, mutual dependence is not allowed (i.e if invitee A is already a dependent of invitee B, invitee B cannot subscribe as a dependent to invitee A); this limitation helps prevent a situation where both invitees are waiting on each other's response.

Once the user requests dependence on one or more other invitees, the chair receives a notice. If the chair has chosen to allow all dependencies when scheduling the meeting, the notice the chair receives will be an FYI only. If the chair has not chosen to allow all dependencies when scheduling the meeting, the notice requesting dependence from the invitee will need to be approved or rejected by the chair. Having this control over the process can enable the chair to prevent dependencies that can be counter-productive.

If the chair rejects the request, the invitee receives a notice informing him of the rejection. If the chair accepts the request or has chosen to allow all dependencies by default, both the dependent invitee and the target invitee(s) receive a notice informing them of the acceptance. At this point if the target invitee(s) has already responded to the meeting invite, the response is forwarded to the dependent invitee. Further, when the target invitee(s) responds or revises a prior response, a copy of the response is sent to the dependent invitee. To protect user privacy, any comments added by the target invitee in the response is removed before forwarding it to the dependent invitee. If the dependent invitee had specified an automatic response based on the response of the target invitee(s), a check is performed every time a response is received from the target invitee(s). If the criteria for an automatic response are satisfied; the specified response for the dependent invitee, is automatically sent to the chair for that meeting.

For example—Susan schedules a meeting for Sep. 1, 2006 10:30-11:30 AM lo discuss possible ways of resolving a customer issue. When scheduling the meeting she does not choose the option to allow all dependencies. The invitees are the development manager Bill, the developers Sam and Martha, the account manager Lisa and the technical support engineer Ross. Sam receives the invite and accepts it. Bill receives the invite and realizes that it would make sense for him to attend this meeting only if Sam or Martha is going. So Bill requests dependence on Sam and Martha, and specifies an automatic response that if Sam or Martha accept the invite then he will accept too and if both decline then he will decline too. Susan receives the request for dependency and approves it. As a result of her approval Bill, Sam and Martha receive a notice that Bill will attend the meeting only if Sam or Martha is going. Bill also receives a notice that Sam has already accepted the invite. The automatic response that Bill had specified kicks in and accepts the invite on behalf of Bill. Martha declines the meeting and adds a comment in her response that she will be unable to attend because she is on vacation that day. Bill receives a copy of her response without her comment. At any point of time, Bill can query Sam and Martha's response status, Also, Susan can view all dependencies among the invitees for this meeting.

The proposed workflow provides for the following in an electronic calendar system. A meeting chair can choose to allow dependencies by default or exercise manual control on each dependency request from invitees. An invitee to a meeting can subscribe as a dependent of one or more other invitees by creating a request for dependence. If the chair has chosen not to allow all dependencies by default, then the chair can approve or turn down a request for dependence from an invitee.

If the chair approves the request or has chosen to allow all dependencies then the following is done. A notice of dependence is sent to the target invitee(s) as an FYI. All the responses for that meeting from the target invitee(s) will automatically be forwarded to the dependent invitee (without any comments). The dependent invitee will have the option of querying the status of target invitees.

The dependent invitee will have the option of choosing an automatic response to the meeting based on the response(s) of the target invitee(s). The chair will have the option of viewing all the dependencies (if any) among invitees for a particular meeting.

Using this workflow provides numerous advantages including, but not limited to some of the following invitees have a clear way of subscribing as a dependent of other invitees. Invitees have a reliable mechanism to avoid meetings that can be unproductive or redundant because another invitee could not make it. The target invitee(s) does not have to respond to multiple queries from the dependent invitee. The chair can keep track of any dependencies between invitees and can plan the agenda accordingly. The chair does not have to keep the dependent invitee updated on the status of the target invitee. The dependent invitee can automate his/her response based on the response of the target invitee(s). The dependent invitee can query the status of the target invitee(s), much like a chair's ability to do so in most calendar systems.

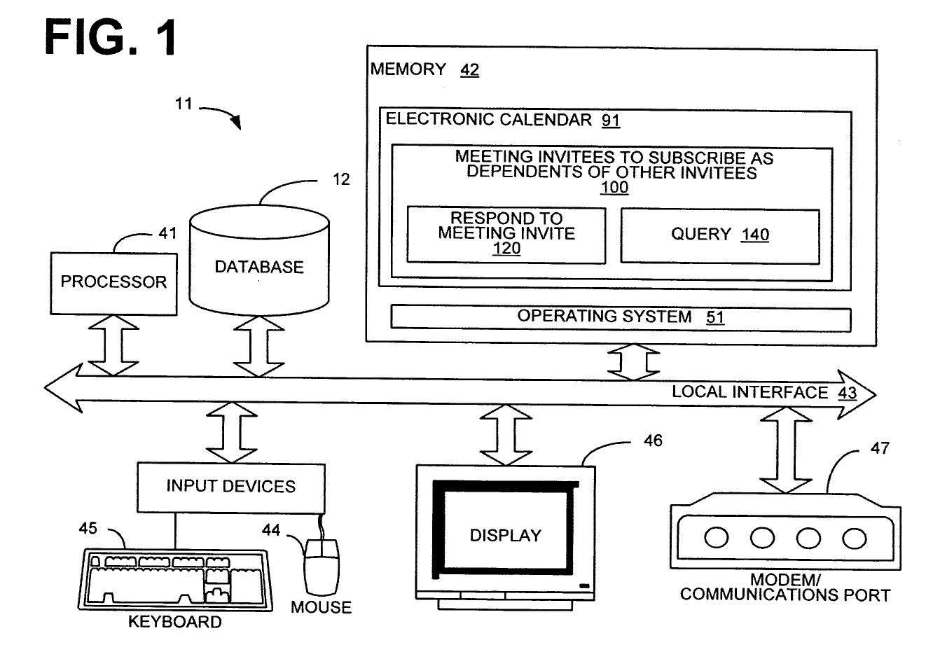

FIG. 1 is a block diagram illustrating an example of a computer II utilizing the Meeting invitees to subscribe as dependents of other invitees system 100 of the present invention. Computer 11 includes, but is not limited to, PCs, workstations, laptops, PDAs, palm devices and the like. Generally, in terms of hardware architecture, as shown in FIG. 1, the computer 11 include a processor 41, memory 42, and one or more input and/or output (I/O) devices (or peripherals) that are communicatively coupled via a local interface 43. The local interface 43 can be, for example but not limited to, one or more buses or other wired or wireless connections, as is known in the art. I-he local interface 43 may have additional elements, which are omitted for simplicity, such as controllers, buffers (caches), drivers, repeaters, and receivers, to enable communications. Further, the local interface 43 may include address, control, and/or data connection's to enable appropriate communications among the aforementioned components.

The processor 41 is a hardware device for executing software that can be stored in memory 42. The processor 41 can be virtually any custom made or commercially available processor, a central processing unit (CPU), data signal processor (DSP) or an auxiliary processor among several processors associated with the computer 11, and a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EEPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 1, the software in the memory 42 includes a suitable operating system (O/S) 51, electronic calendar 91, and the meeting invitees to subscribe as dependents of other invitees system 100 of the present invention. As illustrated, the meeting invitees to subscribe as dependents of other invitees system 100 of the present invention comprises numerous functional components including, but not limited to, the respond to meeting invite module 120 and query module 140.

A non-exhaustive list of examples of suitable commercially available operating systems 51 is as follows (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a Linux operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation).

The operating system 51 essentially controls the execution of other computer programs, and provides scheduling, input-output control, file and data management, memory management, and communication control and related services. It is contemplated by the inventors that the meeting invitees to subscribe as dependents of other invitees system 100 of the present invention is applicable on all other commercially available operating systems.

The meeting invitees to subscribe as dependents of other invitees system 100 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 51. Furthermore, the Meeting invitees to subscribe as dependents of other invitees system 100 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XMfTML, XML, ASP scripts, FORTRAN, COBOL, Perl, Java, ADA, .NET, and the like.

The I/O devices may include input devices, for example but not limited to, a mouse 44, keyboard 45, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing remote devices, other files, devices, systems, or a network), a radio frequency (RF) or other transceiver (not shown), a telephonic interface (not shown), a bridge (not shown), a router (not shown), etc.

If the computer 11 is a PC, workstation, intelligent device or the like, the software in the memory 42 may further include a basic input output system (BIOS) (omitted for simplicity). The BIOS is a set of essential software routines that initialize and test hardware at startup, start the O/S 51, and support the transfer of data among the hardware devices. The BIOS is stored in some type of read-only-memory, such as ROM, PROM, EPROM, EEPROM or the like, so that the BIOS can be executed when the computer 11 is activated.

When the computer 11 is in operation, the processor 41 is configured to execute software stored within the memory 42, to communicate data to and from the memory 42, and to generally control operations of the computer 11 are pursuant to the software. The meeting invitees to subscribe as dependents of other invitees system 100 and the O/S 51 are read, in whole or in part, by the processor 41, perhaps buffered within the processor 41, and then executed.

When the meeting invitees to subscribe as dependents of other invitees system 100 is implemented in software, as is shown in FIG. 1, it should be noted that the meeting invitees to subscribe as dependents of other invitees system 100 can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method.

The meeting invitees to subscribe as dependents of other invitees system I 00 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In an alternative embodiment, where the meeting invitees to subscribe as dependents of other invitees system 100 is implemented in hardware, the meeting invitees to subscribe as dependents of other invitees system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

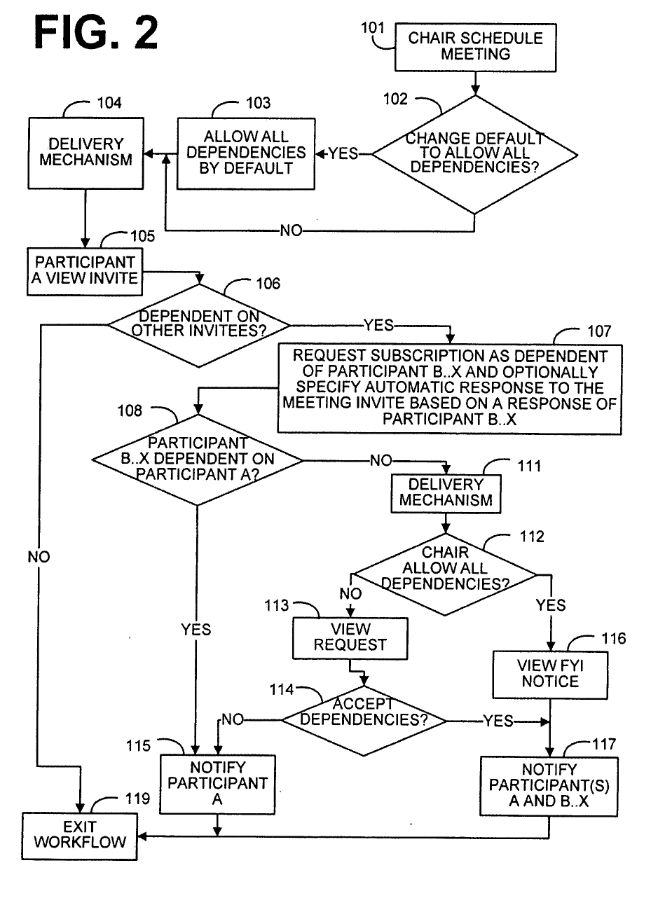

FIG. 2 is a flow chart illustrating an example of the operation of the meeting invitees to subscribe as dependents of other invitees system 100 of the present invention, as shown in FIGS. 1 and 2. The meeting invitees to subscribe as dependents of other invitees system 100 provides dependent invitees a mechanism to formally request or obtain information regarding others attending a meeting with in the workflow framework of a calendar system. This will help such invitees to avoid unproductive or redundant meetings.

First, the meeting invitees to subscribe as dependents of other invitees system 100 is initialized. This initialization may include startup routines and processes embedded in the BIOS of the computer 11. The initialization also includes the establishment of data values for particular data structures utilized in the meeting invitees to subscribe as dependents of other invitees system 100.

For better understanding, Chair will be used to identify the person scheduling the meeting. Participant A refers to a person explicitly invited to the meeting who wishes to subscribe dependence on other participants; i.e. a person who is dependent upon other person(s) explicitly invited to the meeting, and Participant B . . . X refers to person(s) upon whom Participant A depends.

At step 101, the meeting invitees to subscribe as dependents of other invitees system 100 is initialized when a person begins to schedule a meeting. The person scheduling the meaning will hereafter be referred to as the Chair for convenience. At step 102, it is determined if the chair wants to change the default to allow all dependencies for the meeting being scheduled. If it is determined that the chair will not change the default to allow all dependencies, then the meeting invitees to subscribe as dependents or other invitees system 100 skips to step 104. However, if it is determined that the chair will allow a change of the default to allow all dependencies, then the meeting invitees to subscribe as dependents of other invitees system 100 allows all dependencies by default for the scheduled meeting at step 103.

At step 104, each participant noted in the meeting being scheduled is sent the meeting notice by the electronic calendar 91 standard meeting notice delivery system. The meeting notice is then stored in memory. This memory may be static memory, for example database 12 (FIG. 1), or maybe dynamic memory, for example memory 42.

At step 105, Participant A listed in the scheduled meeting views the meeting invitation. At step 106, it is determined if Participant A is dependent upon other participants being invited to the meeting scheduled. This dependency on other invitees could be met if participant A is dependent upon another participant(s) who has been invited. If it is determined at step 106 that there is no dependence upon other invitees, then the meeting invitees to subscribe as dependents of other invitees system 100 skips to exit at step 119.

However, if it is determined at step 106 that Participant A is dependent upon other participants being invited to the meeting scheduled, then at step 107, Participant A requests subscription as being dependent upon Participant B . . . X. At step 107, Participant A can optionally specify an automatic response to the meeting invite based on the response of Participant B . . . X.

At step 108, it is determined if Participant B . . . X has subscribed to dependence on Participant A. If it is determined at step 108 that Participant B . . . X has subscribed to dependence on Participant A, then the dependence requested by Participant A is disallowed and the meeting invitees to subscribe as dependents of other invitees system 100 notifies Participant A of the denied request for dependencies at step 115. If it is determined at step 108 that Participant B . . . X has not subscribed to dependence on Participant A then the meeting invitees to subscribe as dependents of other invitees system 100, notifies the chair of Participant A's desire to be dependent upon Participant B . . . X, at step 111. The notice is then stored in memory. This memory may be static memory, for example database 12 (FIG. 1), or maybe dynamic memory, for example memory 42.

At step 112, it is determined if the chair has previously allowed all dependencies at step 103. If it is determined at step 112 that the chair did allow all dependencies identified at step 103, then the meeting invitees to subscribe as dependents of other invitees system 100 proceeds to step 116. However, if it is determined at step 112 that the chair did not allow all dependencies identified at step 103, the Chair views the new request at step 113.

At step 114, it is determined if the Chair will accept the new dependencies identified at step 107. If it is determined at step 114 that the Chair will not accept the dependencies identified at step 107, then the meeting invitees to subscribe as dependents of other invitees system 100 notifies Participant A of the denied request for dependencies at step 115. The notice is then stored in memory. This memory may be static memory, for example database 12 (FIG. 1), or maybe dynamic memory, for example memory 42.

The meeting invitees to subscribe as dependents of other invitees system 100, then proceeds to step 119 to exit. However, if it is determined at step 114 that the Chair will except the dependencies identified at step 107, then the meeting invitees to subscribe as dependents of other invitees system 100 proceeds to step 117.

At step 116, the chair receives a FYI notice that there were dependent Participants B . . . X invited to the meeting. This notice includes identification of the dependents for each participant explicitly invited to the meeting. The notice is then stored in memory. This memory may be static memory, for example database 12 (FIG. 1), or maybe dynamic memory, for example memory 42.

At step 117, the meeting invitees to subscribe as dependents of other invitees system 100 notifies Participants A and B . . . X of the accepted request for invitation to a scheduled meeting as a dependent of an explicitly invited participant. This notice is then stored in memory. This memory may be static memory, for example database 12 (FIG. 1), or maybe dynamic memory, for example memory 42.

At step 119, the meeting invitees to subscribe as dependents of other invitees system 100 of the present invention then exits.

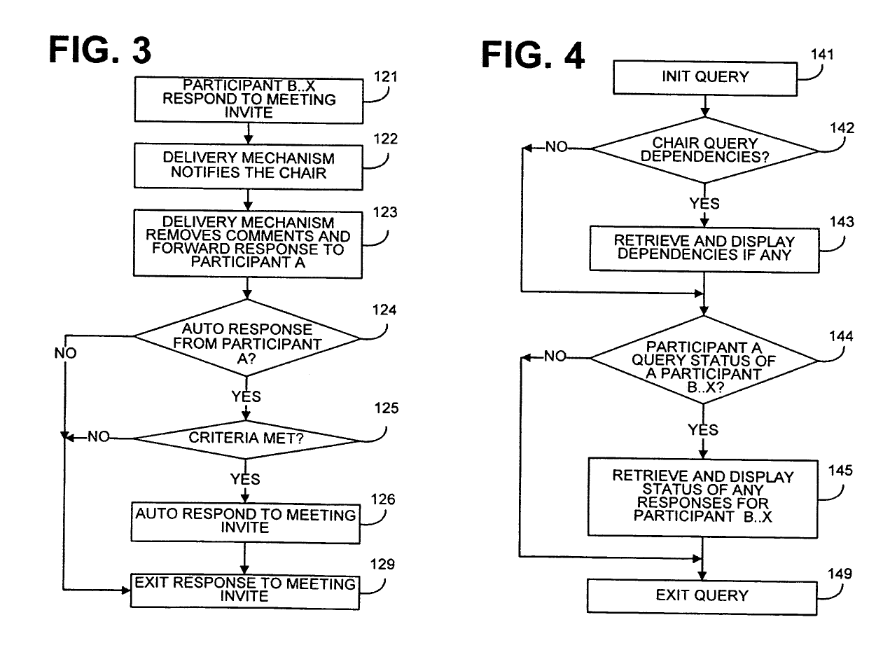

FIG. 3 is a flow chart illustrating an example of the operation of the response to meeting invite module 120 on the computer 11 that is utilized in the meeting invitees to subscribe as dependents of other -invitees system 100 of the present invention, as shown in FIGS. 1. Response to meeting invite module 120 enables dependent participants to receive the responses of the targeted participant(s) to the meeting invitation.

At step 121, Participant B . . . X responds to a meeting invitation sent out at step 117 (FIG. 2). At step 122, the electronic calendar 91 standard delivering mechanism notifies the Chair of Participant B . . . X response to the meeting invitation. At step 123, the electronic calendar 91 standard delivery mechanism removes any comments from Participant B . . . X response and forwards that response to Participant A. These notices are then stored in memory. This memory may be static memory, for example database 12 (FIG. 1), or maybe dynamic memory, for example memory 42.

At step 124, it is determined if Participant A has an auto response set. If it is determined at step 124 that Participant A does not have an auto response set, then the response to meeting invite module 120 proceeds to step 129 to exit. However, if it is determined at step 124 that the auto response is set, then it is determined if the criteria is met for that auto response at step 125.

If it is determined at step 125 that the criteria is not met for auto response, then the response to meeting invite module 120 proceeds to exit at step 129. However, if it is determined at step 125 at the criteria is met for auto response, then the response to meeting invite module 120 responds to the meeting invitation for Participant A based on the set criteria at step 126.

At step 129, the response to meeting invite then exits.

FIG. 4 is a flow chart illustrating an example of the operation of the query module 140 on the computer 11 that is utilized in the meeting invitees to subscribe as dependents of other invitees system 100 of the present invention, as shown in FIG. 1. The query module enables the chair and participants to query and display the status of dependencies.

First at step 141, the query module 140 is initialized. This initialization may include startup routines and processes embedded in the BIOS of the computer 11. The initialization also includes the establishment of data values for particular data structures utilized in the query module 140.

At step 142, it is determined if the chair is querying dependencies. If it is determined at step 142 that the Chair is not querying dependencies, then the query module 140 skips to step 144. However, if it is determined at step 142 that the Chair is querying dependencies, then the query module 140 retrieves and displays all dependencies if any at step 143.

At step 144, it is determined if a dependent participant is querying the status of a response from targeted Participant B . . . X. The Chair may query the status of any responses for any participants. A participant must be dependent upon the other participant(s) to perform a query and can only query the status of a targeted participant.

If it is determined that dependent Participant A is not querying the status of a response from targeted Participant B . . . X, then the query module skips to exit at step 149. However, if it is determined that dependent Participant A is querying the status of a response from targeted Participant B . . . X, then the query module 140 retrieves and displays status of any responses for Participants B . . . X.

At step 149, the query module then exits.

In an alternative embodiment, a standard electronic calendar 91 can be modified to implement the workflow to allow meeting invitees to subscribe as dependents up other invitees as taught in the present application by implementing the following changes.

Change the user interface for scheduling a meeting to include an option to allow all dependencies for the meeting and for responding to a meeting invite to include a provision to request dependence.

The user should be able to select the targets from a list of the invitees to that meeting and the user should be unable to select an invitee who already has subscribed as a dependent of the current user (to prevent mutual dependence). The user should be able to define an automated response based on the target invitee response.

A notification mechanism is added to deliver the dependence subscription request to the Chair. If the Chair has chosen to allow all dependencies, this notice should be an FYI only or the chair should be able to approve or reject the request. The notification mechanism also includes the ability to deliver the chair's response to the dependent invitee. If the response is an “Accept” or if the chair has chosen to allow all dependencies by default, the mechanism delivers the notice of acceptance to both the dependent and the target invitee, else only to the dependent invitee.

A mechanism is added to save the details of the request in the calendar system so that it can be retrieved when needed, will forward responses from the target invitee for this meeting to the dependent invitee, after stripping out any comments, and will check the auto response criteria (if the user has set any), every time a response notice is received from a target invitee. If the criteria are satisfied, the auto response is effected.

An option is added in the user interface to allow the dependent invitee to query the status of the target invitee(s), and for the &hair to view all dependence among the invitees for the meeting.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A meeting system for managing a meeting notice, the system comprising:
a dependency set module that enables a participant to define at least one dependent participant and optionally specify an automatic response to the meeting invitation based on the targeted participant's response;
a determination module that determines if a person scheduling a meeting will allow a participant to subscribe as a dependent participant of at least one other participant of the meeting. Wherein the dependency determination module, to prevent mutual dependence between two participants, will not allow the participant to subscribe as a dependent if the targeted participant is indicated as a dependent of the requesting participant; and
a delivery module that delivers a dependency notice to the participant and, to the at least one targeted participant if the person scheduling a meeting has chosen to allow dependencies by default, wherein the delivery module delivers a FYI notice to the person scheduling a meeting if dependencies are allowed by default and delivers a response to the meeting invite if the dependent participant has specified an automatic response based on the targeted participant's response.

2. The system of claim 1, wherein the dependency determination module enables a person scheduling the meeting to allow at least one dependent explicitly.

3. The system of claim 2, further comprising a query module that further comprises:
a dependent query module that enables dependent participant to query the status of the targeted participant(s);
a second query module that enables the person scheduling the meeting to view all dependencies among participants for the meeting.

4. A method for managing a meeting notice, comprising:
enabling a participant to define a dependence on least one other participant and optionally specify an automatic response to the meeting based on the at least one other participant's response;
determining if the targeted participant is indicated as a dependent on the requesting participant and if found to be true, disallowing the dependence;
determining if the person scheduling the meeting allows dependencies by default;
delivering a request to the person scheduling the meeting for approval, if the person scheduling the meeting does not allow dependencies by default;
determining if the person scheduling the meeting allows the requested dependency explicitly by approving the request;
delivering the dependency notice to the dependent participant and, to the at least one targeted participant if the person scheduling the meeting has chosen to allow the dependency;
determining if the dependent participant has specified an automatic response to the invitation based on the at least one targeted participant's response; and
delivering a response based on the at least one targeted participant's response, if the dependent participant has specified an automatic response.

5. The method of claim 4, further comprising:
enabling the dependent participant to query the status of the at least one targeted participant;
enabling the person scheduling the meeting to view all dependencies among the participants for the meeting.

6. The method of claim 5, further comprising:
delivering a FYI notice to the person scheduling a meeting if all dependencies are allowed by default.
